(19) United States
(12) Patent Application Publication
(10) Pub. No.: US 2023/0077977 A1
(43) Pub. Date: Mar. 16, 2023

(54) VEHICLE CONTROL DEVICE AND VEHICLE CONTROL SYSTEM

(71) Applicant: KABUSHIKI KAISHA TOKAI RIKA DENKI SEISAKUSHO, Aichi (JP)

(72) Inventors: Naofumi KATO, Aichi (JP); Takashi NAGAO, Aichi (JP); Tetsuya EGAWA, Aichi (JP); Hitoshi MURAKI, Aichi (JP); Masanori KOSUGI, Aichi (JP)

(21) Appl. No.: 17/800,822

(22) PCT Filed: Feb. 24, 2021
(86) PCT No.: PCT/JP2021/006916

§ 371 Date: Aug. 18, 2022

(30) Foreign Application Priority Data
Feb. 28, 2020 (JP) 2020-033129

(51) Int. Cl. H04M 1/72463; B60R 25/24

(52) U.S. Cl. CPC H04M 1/72463; B60R 25/24; B60R 2325/205

(57) ABSTRACT

A vehicle control device includes at least one allowed function that a user is allowed to use and at least one disallowed function that the user is not allowed to use in a plurality of functions of at least one mounted electronic device, and a control unit to perform at least one of changing at least one of the disallowed function into the allowed function and changing at least one of the allowed function into the disallowed function, based on obtained function information about the allowed function and the disallowed function.

### CROSS-REFERENCES TO RELATED APPLICATIONS

The present patent application claims the priority of Japanese patent application No. 2020/033129 filed on Feb. 28, 2020, and the entire contents of Japanese patent application No. 2020/033129 are hereby incorporated by reference.

### TECHNICAL FIELD

The present invention relates to a vehicle control device and a vehicle control system.

### BACKGROUND ART

An in-vehicle unit to be arranged in the dashboard section of a vehicle is known which is provided with a center module to which various optional modules can be removably attached (e.g., see Patent Literature 1).

The center module of the in-vehicle unit has pre-assembled units having predetermined functions and includes at least one module fitting portion. At least one optional module having a predetermined function different from the functions of the units can be detachably fitted to the module fitting portion of the center module.

### CITATION LIST

### Patent Literature

Patent Literature 1: JP H11/180222 A

### SUMMARY OF INVENTION

### Technical Problem

The in-vehicle unit disclosed in Patent Literature 1 has a problem that when newly adding a unit, the unit to be added must be purchased and further assembled to the center module, which requires time and efforts.

It is an object of the invention to provide a vehicle control device and a vehicle control system that are capable of easily adding a new function.

### Solution to Problem

According to an embodiment of the invention, a vehicle control device comprises:
at least one allowed function that a user is allowed to use and at least one disallowed function that the user is not allowed to use in a plurality of functions of at least one mounted electronic device; and
a control unit to perform at least one of changing at least one of the disallowed function into the allowed function and changing at least one of the allowed function into the disallowed function, based on obtained function information about the allowed function and the disallowed function.

According to another embodiment of the invention, a vehicle control system comprises:
a terminal comprising a storage unit to store function information about at least one allowed function that the user is allowed to use and at least one disallowed function that the user is not allowed to use among functions of at least one electronic device mounted on a vehicle, and a first communication unit to output the function information; and
a vehicle control device comprising a second communication unit to communicate with the terminal through the first communication unit, and a control unit to perform at least one of changing at least one of the disallowed function into the allowed function and changing at least one of the allowed function into the disallowed function, based on the function information obtained from the terminal through the second communication unit.

### Advantageous Effects of Invention

According to an embodiment and another embodiment of the invention, it is possible to provide a vehicle control device and a vehicle control system that are capable of easily adding a new function.

### BRIEF DESCRIPTION OF DRAWINGS

FIG. 1 is an explanatory diagram illustrating a vehicle control system in an embodiment.

FIG. 2A is a block diagram illustrating a server of the vehicle control system in the embodiment.

FIG. 2B is a block diagram illustrating a terminal of the vehicle control system in the embodiment.

FIG. 2C is a block diagram illustrating a vehicle control device of the vehicle control system in the embodiment.

FIG. 3 is a block diagram illustrating a vehicle communication system in a vehicle of the vehicle control system in the embodiment.

FIG. 4A shows a function purchase screen on the terminal of the vehicle control system in the embodiment.

FIG. 4B shows a screen of the terminal of the vehicle control system in the embodiment at the time of fingerprint registration or fingerprint authentication.

FIG. 5 is a timing chart relating to addition of a function in the vehicle control system in the embodiment.

### DESCRIPTION OF EMBODIMENTS

### Summary of the Embodiments

A vehicle control device in an embodiment includes at least one allowed function that a user is allowed to use and at least one disallowed function that the user is not allowed to use in a plurality of functions of at least one mounted electronic device, and a control unit to perform at least one of changing at least one of the disallowed functions into the allowed function and changing at least one of the allowed functions into the disallowed function based on obtained function information about the allowed function and the disallowed function.

This vehicle control device can change the disallowed function to the allowed function and thereby add an available function. Therefore, a new function can be added easily as compared to when an electronic device, etc., is newly installed to add a function.

A vehicle control system in an embodiment of the invention includes a terminal comprising a storage unit to store function information about at least one allowed function that the user is allowed to use and at least one disallowed function that the user is not allowed to use among functions of at least one electronic device mounted on a vehicle, and a first communication unit to output the function information, and a vehicle control device comprising a second communication unit to communicate with the terminal through the first communication unit, and a control unit to perform at least one of changing at least one of the disallowed functions into the allowed function and changing at least one of the allowed functions into the disallowed function based on the function information obtained from the terminal through the second communication unit.

This vehicle control system can change the disallowed function to the allowed function by an operation performed on the terminal and thereby add an available function. Therefore, a new function can be added easily as compared to when an electronic device, etc., is newly installed to add a function.

### Embodiment

(General Configuration of a Vehicle Control System 1)

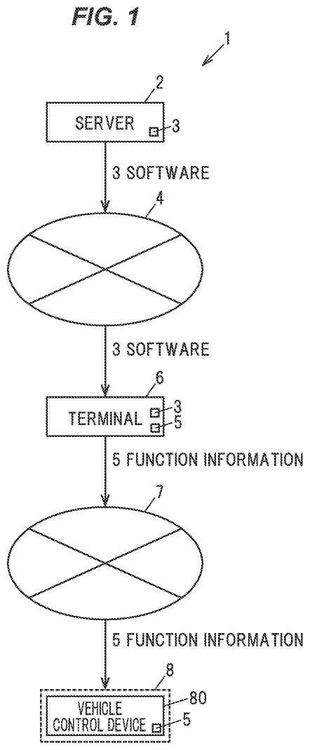

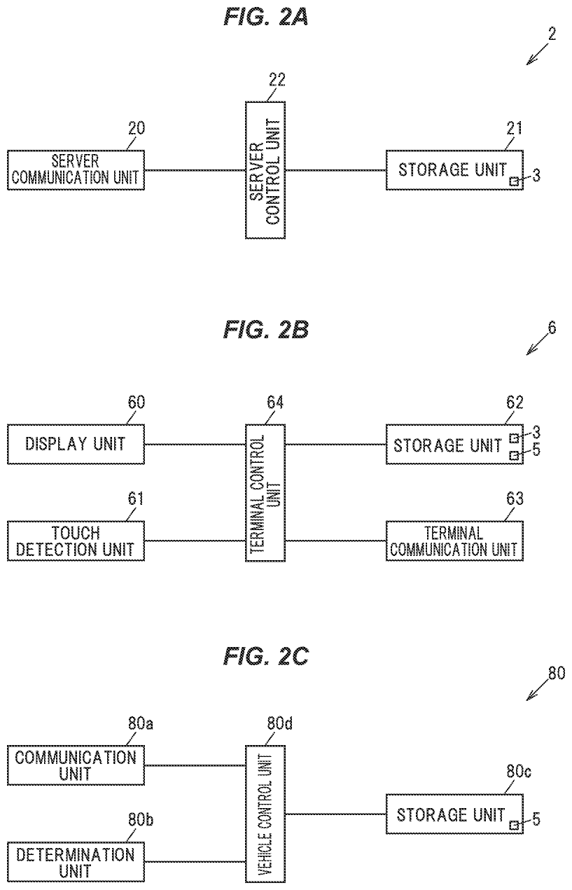

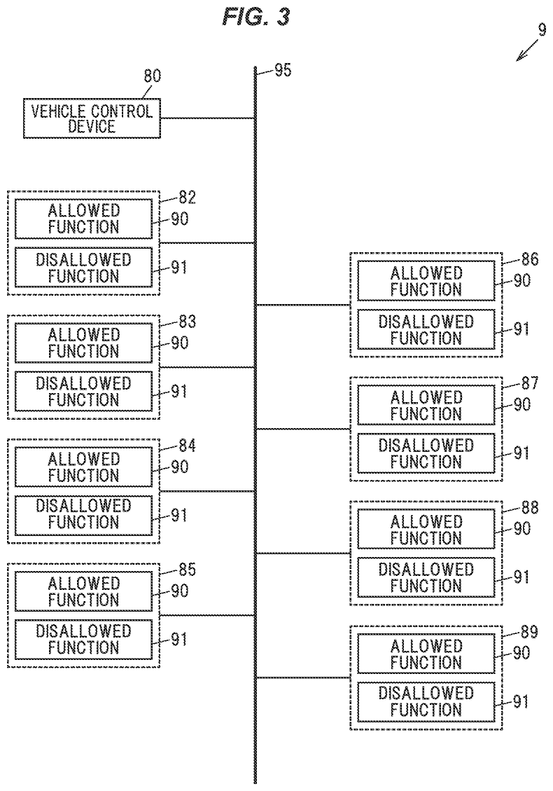

FIG. 1 is an explanatory diagram illustrating a vehicle control system. FIG. 2A is a block diagram illustrating a server. FIG. 2B is a block diagram illustrating a terminal, and FIG. 2C is a block diagram illustrating a vehicle control device. FIG. 3 is a block diagram illustrating a vehicle communication system. In FIG. 1, a main flow of information is indicated by arrows.

As shown in FIG. 2C, a vehicle control device 80 in the present embodiment includes at least one allowed function (an allowed function 90 described later) that a user is allowed to use and at least one disallowed function (a disallowed function 91 described later) that the user is not allowed to use in plural functions of at least one mounted electronic device, and a control unit (a vehicle control unit 80d described later) to perform at least one of changing at least one of the disallowed functions (91) into the allowed function (90) and changing at least one of the allowed functions (90) into the disallowed function (91) based on obtained function information 5 about the allowed function (90) and the disallowed function (91).

The vehicle control device 80 is mounted on the vehicle 8. The vehicle 8 is sold in different grades with different prices. Plural electronic devices are also mounted on the vehicle 8. As an example, the highest grade vehicle 8 is in a state in which functions with high added-value among executable functions of the plural electronic devices are available, i.e., can be used as the allowed functions (90) in addition to the standard functions. On the other hand, as an example, the lowest grade vehicle 8 is in a state in which only the standard functions among executable functions of the plural electronic devices can be used, i.e., mainly the functions with high added-value are the disallowed functions (91). In this way, for the vehicle 8, all electronic devices are mounted rather than installing different electronic devices depending on the grade, and available functions, i.e., the allowed functions (90) are different with different grades.

The vehicle control device 80 is mounted on the vehicle 8 that is rented for a fee or shared, the vehicle 8 used as so-called rental car or car sharing. For the vehicle 8, the allowed functions (90) and the disallowed functions (91) are set according to, e.g., a rental fee. That is, when the rental fee is high, functions with high added-value are set as the allowed functions (90). Meanwhile, when the rental fee is low, the standard functions are set as the allowed functions (90).

Furthermore, the vehicle 8 is also used as a vehicle that is shared by family members and provides different available functions for each family member. In this vehicle 8, e.g., functions selected according to preferences of family members are set as the allowed functions (90) and a terminal 6 of each family member stores the selected functions as the function information 5.

As shown in FIG. 1, the vehicle 8 is included in the vehicle control system 1. As shown in FIGS. 2A, 2B, 2C and 3, the vehicle control system 1 includes the terminal 6, which has a storage unit 62 to store the function information 5 about at least one allowed function 90 that the user is allowed to use and at least one disallowed function 91 that the user is not allowed to use among functions of at least one electronic device mounted on the vehicle 8 and a terminal communication unit 63 as the first communication unit to output the function information 5, and the vehicle control device 80 which has a communication unit 80a as the second communication unit to communicate with the terminal 6 through the terminal communication unit 63 and the vehicle control unit 80d to perform at least one of changing at least one of the disallowed functions 91 into the allowed function 90 and changing at least one of the allowed functions 90 into the disallowed function 91 based on the function information 5 obtained from the terminal 6 through the communication unit 80a.

As shown in FIG. 1, the vehicle control system 1 further includes a server 2 that transmits software 3, which generates the function information 5, to the terminal 6. The server 2 and the terminal 6 are connected through a network 4. The terminal 6 and the vehicle 8 are connected through a vehicle LAN (=Local Area Network) 7. The vehicle control system 1 includes the server 2, the terminal 6, and the vehicle 8.

(Configuration of the Server 2)

As shown in FIG. 2A, the server 2 includes a server communication unit 20, a storage unit 21, and a server control unit 22. The server communication unit 20 is configured to reciprocally exchange signals and information, etc., with the terminal 6 via the network 4. The storage unit 21 is composed of a storage device such as a semiconductor memory, an HDD (=Hard Disk Drive), or an SSD (=Solid State Drive). The software 3 is stored in the storage unit 21.

The server control unit 22 is a microcomputer composed of a CPU (=Central Processing Unit) performing calculation and processing, etc., of the acquired data according to a stored program, and a RAM (=Random Access Memory) and a ROM (=Read Only Memory) as semiconductor memories, etc. The ROM stores a program for operation of the server control unit 22. The RAM is used as a storage area to temporarily store calculation results, etc.

(Configuration of the Software 3)

The software 3 is a program that activates and deactivates functions of electronic devices mounted on the vehicle 8, i.e., manages the allowed functions 90 and the disallowed functions 91. The software 3 in the present embodiment is mainly used to change the disallowed functions 91 to the allowed functions 90, but it is not limited thereto and it is also used to change the allowed functions 90, which have been used up to the present, to the disallowed functions 91.

The change from the allowed functions 90 to the disallowed functions 91 is carried out, e.g., when the allowed functions 90 have an expiration date, when the existing allowed functions 90 become unnecessary due to new allowed functions 90, or when the allowed functions 90 are deprecated, etc.

As an example, the general outline of the method for changing the disallowed function 91 to the allowed function 90 is as follows. For example, a user operates the terminal 6 to connect to the server 2 through the network 4 and purchases the software 3 to change the disallowed function 91 to the allowed function 90. Next, the user starts up the software 3 downloaded from the server 2. The function information 5 is created, e.g., after the software 3 is started up. The function information 5 includes information about the allowed function 90 and the disallowed function 91.

When the vehicle 8 is rented for a fee, e.g., the fee for renting the vehicle 8 is included in the purchase price of the software 3. Which allowed functions 90 are available depends on the amount of the rental fee.

(Configuration of the Network 4)

The network 4 connects the server 2 and the terminal 6 wirelessly or wired. The network 4 in the present embodiment is Internet. Wi-Fi (registered trademark) or Bluetooth (registered trademark), etc., may be used as the network 4 when the server 2 is located in a dealer's building or a repair shop, etc., of the vehicle 8.

(Configuration of the Terminal 6)

The terminal 6 is, e.g., a portable terminal such as smartphone or tablet. As shown in FIG. 2B, the terminal 6 includes a display unit 60, a touch detection unit 61, the storage unit 62, the terminal communication unit 63, and a terminal control unit 64.

The display unit 60 is, e.g., a liquid crystal display or an organic EL (=Electro-Luminescence) display. The touch detection unit 61 is superimposed on the display unit 60. The touch detection unit 61 is a capacitive multi-touch sensor formed of plural transparent electrodes that intersect while maintaining insulation. The storage unit 62 is a semiconductor memory. The software 3 downloaded from the server 2 and the function information 5 are stored in the storage unit 62. The terminal communication unit 63 communicates with the server 2 through the network 4 and communicates with the vehicle 8 through the vehicle LAN 7.

The terminal control unit 64 is a microcomputer composed of a CPU performing calculation and processing, etc., of the acquired data according to a stored program, and a RAM and a ROM as semiconductor memories, etc. The ROM stores a program for operation of the terminal control unit 64. The RAM is used as a storage area to temporarily store calculation results, etc.

(Configuration of the Vehicle LAN 7)

The vehicle LAN 7 is a network which enables reciprocal exchange of signals or information, etc., with the terminal 6 by wired or wireless connection. The vehicle LAN 7 in the present embodiment is Wi-Fi (registered trademark) or Bluetooth (registered trademark), etc.

(Configuration of the Vehicle Control Device 80)

As shown in FIG. 3, the vehicle 8 includes a vehicle communication system 9 in which plural mounted electronic devices are interconnected by an in-vehicle LAN 95. The in-vehicle LAN 95 is, e.g., a network for vehicle which enables reciprocal exchange of signals or information, etc., by wired or wireless connection, such as CAN (Controller Area Network) or LIN (Local Interconnect Network).

The vehicle control device 80 and the plural electronic devices are connected to the in-vehicle LAN 95. As shown in FIG. 2C, the vehicle control device 80 includes the communication unit 80a, a determination unit 80b, a storage unit 80c, and the vehicle control unit 80d. The communication unit 80a communicates with the terminal 6 through the vehicle LAN 7 and also communicates with the plural electronic devices through the in-vehicle LAN 95.

The determination unit 80b determines whether or not the terminal 6 is present in a vehicle cabin. When the determination unit 80b determines that the terminal 6 is present in the vehicle cabin, the vehicle control unit 80d performs at least one of changes on the allowed function 90 and on the disallowed function 91 based on the function information 5 obtained from the terminal 6. In other words, changes on the allowed function 90 and on the disallowed function 91 are not performed when the terminal 6 is located outside the vehicle 8.

The storage unit 80c is a semiconductor memory. The vehicle control unit 80d is a microcomputer composed of a CPU performing calculation and processing, etc., of the acquired data according to a stored program, and a RAM and a ROM as semiconductor memories, etc. The ROM stores a program for operation of the vehicle control unit 80d. The RAM is used as a storage area to temporarily store calculation results, etc.

When the terminal 6 is located outside the vehicle 8, the vehicle control unit 80d of the vehicle control device 80 turns a function of allowing for locking and unlocking of the vehicle 8 into the allowed function 90 based on the function information 5 obtained from the terminal 6. That is, the terminal 6 serves as an electronic key of the vehicle 8. At this time, the terminal 6 communicates with the vehicle control device 80, and when the terminal 6 is a device registered to the vehicle 8, the terminal 6 serves as an electronic key. This authentication is successfully completed when, e.g., information of the terminal 6 included in the function information 5 matches information registered to the vehicle 8.

When the vehicle 8 is rented out, the user to whom it is rented can use the terminal 6 as an electronic key by downloading and starting up the software 3 on his/her terminal 6 and changing the disallowed function 91 related to the electronic key to the allowed function 90.

As an example, the plural electronic devices are a start switch 82, a locking device 83, an air conditioning device 84, a navigation device 85, a window device 86, a wiper device 87, a vehicle setting device 88, and an automated driving device 89 as shown in FIG. 3, but it is not limed thereto. Each of these electronic devices has the allowed functions 90 and the disallowed functions 91, i.e., activated functions and deactivated functions. In this regard, the electronic devices also include various sensors and cameras, etc.

The start switch 82 is a push switch. The start switch 82, when a push operation is performed on an operating surface thereof, causes a drive device of the vehicle 8 to start in case of an internal combustion engine (an engine), causes preparation for drive in case of a motor to allow for a current supply to the motor, and causes start or preparation for start according to the drive device prioritized at the time of start in case of a hybrid of an internal combustion engine and a motor.

The start switch 82 has, e.g., a biometric information reading device on the operating surface and has a biometric authentication function using this biometric information reading device. This biometric authentication function is set to the disallowed function 91 depending on the grade of the vehicle 8. The start switch 82 also has other functions such as ON (allowing all electronic devices to be used) and ACC (allowing some of electronic devices to be used), etc., in addition to starting and stopping the drive device.

The locking device 83 is a device to lock and unlock portions to be opened and closed, such as a hood, doors and a trunk lid, etc., of the vehicle 8. The locking device 83 has functions such as unlocking the hood, locking and unlocking the doors, automatically locking and automatically unlocking the doors, and unlocking the trunk lid. These functions of the locking device 83 are provided as the allowed function 90 or the disallowed function 91.

Automatic door locking is a function of automatically locking the doors when the authenticated terminal 6 moves out of a range defined based on the vehicle 8, and a function of automatically locking the doors when the vehicle 8 travels at not less than a predetermined speed. Automatic door unlocking is a function of automatically unlocking the doors when the terminal 6 capable of being authenticated enters the range and authentication is then successfully completed.

The air conditioning device 84 is a device to adjust temperature in the vehicle cabin. The air conditioning device 84 has functions such as heating setting, cooling setting, fan-only setting, air conditioning temperature setting, air volume setting, air vent setting, demisting the windshield, demisting the rear window, switching between recirculating and fresh air, auto setting, setting for driver and front passenger seat sides, setting for rear seat side, air purification in the vehicle cabin, and personal setting. These functions of the air conditioning device 84 are provided as the allowed function 90 or the disallowed function 91.

Setting for driver and front passenger seat sides is a function of changing the settings for each of the driver's seat and the front passenger seat. Setting for rear seat side is a function of allowing various settings for the rear seats. Personal setting is a function of setting to an air conditioning temperature and an air volume which are set for each user.

The navigation device 85 is a device to display a map and guide a route to a set destination. The navigation device 85 has functions such as displaying a map around the current location, map scale setting, destination setting, registered location setting, recording history, displaying frequent destinations, registering home, searching destination, searching and displaying restaurants or gas stations, etc., registering destinations to icons and buttons, route guidance, displaying plural routes, displaying a fee for each route, and scrolling the route. These functions of the navigation device 85 are provided as the allowed function 90 or the disallowed function 91.

Registration of destinations to icons and buttons is a function of registering destinations to icons displayed on the display unit or to physical buttons provided on the main body of the navigation device 85 and searching routes to a registered destination when operated. Scrolling the route is a function of displaying to follow the searched route from the current location to the destination.

The window device 86 is a device to open/close front seat-side windows, open/close rear seat-side windows if any, and open/close a sunroof if any. The window device 86 has functions such as opening/closing the front seat-side and rear seat-side windows, opening/closing the sunroof, fully opening and closing the front seat-side and rear seat-side windows, on/off of a lock switch, and opening/closing by a predetermined amount. These functions window device 86 are provided as the allowed function 90 or the disallowed function 91.

The lock switch is a switch that, when on, does not allow the window to be driven even if a child operates a window opening/closing switch. On/off of the lock switch is a function of turning this lock switch on and off. Opening and closing by a predetermined amount is a function of opening and closing the front seat-side and rear seat-side windows and the sunroof by a predetermined amount when a predetermined operation is performed on switches for opening/closing the windows and the sunroof.

The wiper device 87 is a device to drive windscreen wipers and a rear wiper. The wiper device 87 has functions such as driving the windscreen wipers, driving the rear wiper, setting intermittent drive and drive speed, automatic activation, and spraying windscreen washer fluid. These functions of the wiper device 87 are provided as the allowed function 90 or the disallowed function 91.

The vehicle setting device 88 is a device to configure the settings for the vehicle 8. The vehicle setting device 88 has functions such as seat position setting, steering wheel position setting, outside mirror angle setting, anti-glare mirror setting, driving mode setting, setting brightness of the display device, setting angle of headlights, setting high and low beam of the headlights, fog light setting, sound volume setting, and battery setting. These functions of the vehicle setting device 88 are provided as the allowed function 90 or the disallowed function 91.

Anti-glare mirror settings are functions such as turning on/off a mechanism to suppress light reflection on a room mirror, and adjusting the angle of the room mirror. Driving mode setting is a function of switching the driving characteristics of the vehicle 8. The driving modes include, e.g., a mode enabling stable driving even on, e.g., bad roads such as rainy or snowy roads, and a mode allowing for sports driving. In each driving mode, setting of a driving assistance device such as a skid prevention device, a response of the drive device or an accelerator, setting of steering wheel input angle and a steering angle of wheels, and suspension setting, etc., are optimized. Battery setting is a function of setting usable capacity.

The automated driving device 89 is a device to control automated driving. The automated driving device 89 provides functions such as automated driving, lane keeping, forward collision warning, forward collision avoidance braking, cruise control, summoning the vehicle, and parking assistance, etc. These functions of the automated driving device 89 are provided as the allowed function 90 or the disallowed function 91.

Automated driving includes functions such as automated driving to an entered destination, automated driving to an entered registered location, and automated driving to a location determined by the automated driving device 89. Forward collision warning is a function of providing a warning when there is a high probability of collision with an obstacle such as a vehicle in front. Forward collision avoidance braking is a function of driving a braking device to avoid collision when there is a high probability of collision with an obstacle such as a vehicle in front. Summoning the vehicle is a function of summoning the vehicle to a location where the user operated. Parking assistance is a function of parking the vehicle in a designated parking area. The function of optimizing the route is a function of reducing time to the destination by appropriately changing lanes.

Next, an operation of the vehicle control system 1 in the present embodiment will be described in reference to each drawing. An example of when the user adds the biometric authentication function to the start switch 82 will be described below. The general outline of the method in this case is as below. In this regard, the biometric information is a fingerprint in the present embodiment, but is not limited thereto and may be another biometric information such as vein. In the vehicle control system 1, when the vehicle 8 has. e.g., a face authentication function, a function of accepting an operation on the start switch 82 upon successful face authentication may be the allowed function 90.

The terminal 6 has, based on the software 3 obtained from the server 2, functions of generating the function information 5 and reading and transmitting user's biometric information as registered biometric information to the start switch 82 through the vehicle control device 80. The vehicle control device 80 changes the biometric authentication function pre-installed on the start switch 82 from the disallowed function 91 to the allowed function based on the function information 5 obtained from the terminal 6. The start switch 82 performs biometric authentication by comparing the biometric information, which is read with the biometric authentication function when an operation is performed, to the registered biometric information registered through the terminal 6. Then, when the biometric authentication is successfully completed, the start switch 82 outputs a signal to start, or prepare to start, the drive device.

(Operation)

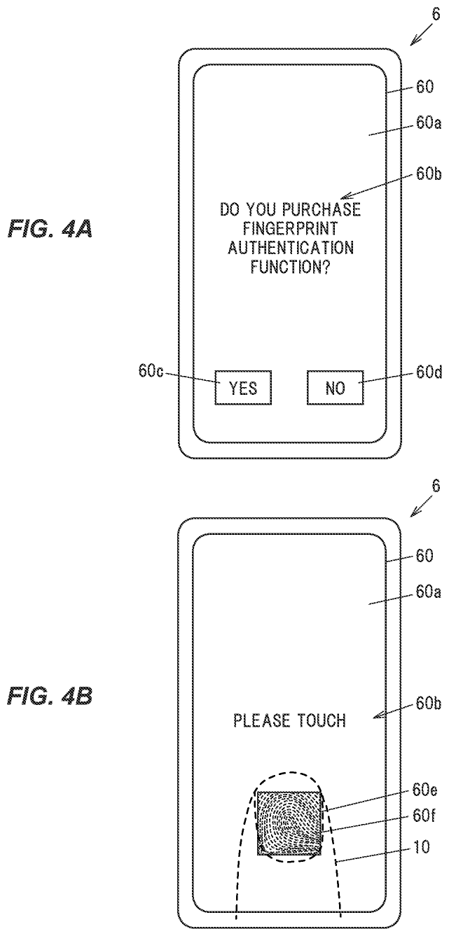

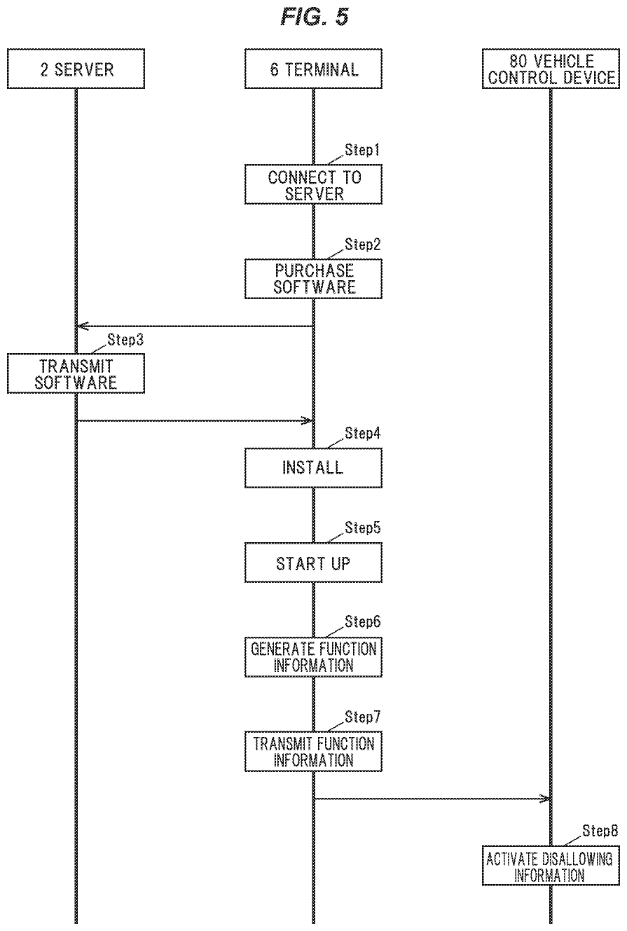

FIG. 4A shows an example of a function purchase screen on the terminal, and FIG. 4B shows an example of a screen at the time of fingerprint registration or fingerprint authentication. FIG. 5 shows an example of a timing chart relating to addition of a function. This operation activates a fingerprint authentication function as the biometric authentication function.

The user operates the terminal 6 and connects it to the server 2 (Step 1). Next, after connecting to the server 2, the user selects the fingerprint authentication function to purchase and then purchases the software 3 to add the fingerprint authentication function (Step 2).

FIG. 4A shows an example of a display screen 60a shown on the display unit 60 of the terminal 6. The display screen 60a shows a message 60b about the purchase of the fingerprint authentication function, an icon 60c to place an order, and an icon 60d to cancel and not purchase. The user performs a touch operation on the icon 60c showing “Yes” to place an order or performs a touch operation on the icon 60d showing “No” to cancel.

When a touch operation is performed on the icon 60c showing “Yes”, the server 2 transmits the software 3 selected for purchase to the terminal 6 (Step 3).

The terminal 6 downloads the software 3 from the server 2 and installs it (Step 4). Then, the terminal 6 starts up the installed software 3 based on an operation performed by the user (Step 5).

The software 3, when started up on the terminal 6, generates the function information 5 to change the purchased fingerprint authentication function, which is the disallowed function 91, to the allowed function 90 to activate the fingerprint authentication function (Step 6). Starting up the software 3 causes the terminal 6 to have a function of reading the biometric information, i.e., fingerprints, with the touch detection unit 61.

After starting up the software 3, the user makes the terminal 6 read biometric information 60f, which is information of a fingerprint of an operating finger 10, to register biometric information used for fingerprint authentication to the start switch 82, as shown in FIG. 4B. The biometric information 60f is transmitted, as registered biometric information for identification of the user, to the start switch 82. Even if a person other than the user operates the start switch 82, fingerprint authentication is not successfully completed since the biometric information 60f of the user is registered to the start switch 82.

After the user gets in the vehicle 8, the terminal 6 transmits the function information 5, which is generated by the software 3, to the vehicle control device 80 through the vehicle LAN 7 (Step 7).

Once obtaining the function information 5 through the terminal 6 and the vehicle LAN 7, the vehicle control unit 80d of the vehicle control device 80 changes the fingerprint authentication function, which is the disallowed function 91, to the allowed function 90 based on the function information 5 (Step 8).

After the fingerprint authentication function is changed to the allowed function 90, the terminal 6 transmits the biometric information 60f of the operating finger 10, which is read for registration, as registered biometric information to the start switch 82 through the vehicle LAN 7 and the vehicle control device 80. A reading area 60e shown in FIG. 4B is a portion of the touch detection unit 61 and is an area for a fingerprint reading function added by the software 3. The user provides the biometric information 60f by touching the reading area 60e with a finger he/she wants to register. As a modification, the registered biometric information may be included in the function information 5.

The start switch 82 performs biometric authentication by comparing the biometric information, which is read with the biometric authentication function when the operation is performed, to the biometric information 60f registered through the terminal 6.

(Effects of the Embodiment)

The vehicle control system 1 in the present embodiment is capable of easily adding new functions. In this vehicle control system 1, all executable functions of electronic devices mounted on the vehicle 8 are divided into the allowed functions 90 and the disallowed functions 91. Without having to purchase and install an electronic device that executes a desired function, the user can use the desired function by changing the disallowed function 91 to the allowed function 90 by the software 3 purchased from the server 2. Therefore, the vehicle control system 1 can easily add new functions without spending time and effort since the user does not need to purchase and install an electronic device having a desired function.

The vehicle control system 1 preliminarily includes substantially all functions executable by the plural electronic devices mounted on the vehicle 8. Therefore, it is not necessary to purchase electronic devices to add new functions and the cost is thus reduced.

In the vehicle control system 1, it is possible to change the allowed functions 90 and the disallowed functions 91 for each terminal 6. Therefore, as compared to when it is not possible to change, different functions can be available for different family members.

In the vehicle control system 1, when the vehicle 8 is used as a rental vehicle or a vehicle rented out for car sharing, a function of the electronic key can be changed to the allowed function 90 by purchasing the software 3 through the server 2 and can be rented without directly handing over the key to the contracted user. In addition, in the vehicle control system 1, it is possible to change available functions for each contracted user according to the amount of rental fee.

Although some embodiment and modifications of the invention have been described, these embodiment and modifications are merely examples and the invention according to claims is not to be limited thereto. These new embodiment and modifications thereof may be implemented in various other forms, and various omissions, substitutions and changes, etc., can be made without departing from the gist of the invention. In addition, not all combinations of the features described in these embodiment and modifications are necessary to solve the problem of the invention. Further, these embodiment and modifications thereof are included within the scope and gist of the invention and also within the invention described in the claims and the range of equivalency.

### REFERENCE SIGNS LIST

1 VEHICLE CONTROL SYSTEM
2 SERVER
3 SOFTWARE
5 FUNCTION INFORMATION
6 TERMINAL
8 VEHICLE
60f BIOMETRIC INFORMATION
80 VEHICLE CONTROL DEVICE
80b DETERMINATION UNIT
80d VEHICLE CONTROL UNIT
82 START SWITCH
83 LOCKING DEVICE
90 ALLOWED FUNCTION
91 DISALLOWED FUNCTION

1. A vehicle control device, comprising:
at least one allowed function that a user is allowed to use and at least one disallowed function that the user is not allowed to use in a plurality of functions of at least one mounted electronic device; and
a control unit to perform at least one of changing at least one of the disallowed function into the allowed function and changing at least one of the allowed function into the disallowed function, based on obtained function information about the allowed function and the disallowed function.

2. A vehicle control system, comprising:
a terminal comprising a storage unit to store function information about at least one allowed function that the user is allowed to use and at least one disallowed function that the user is not allowed to use among functions of at least one electronic device mounted on a vehicle, and a first communication unit to output the function information; and
a vehicle control device comprising a second communication unit to communicate with the terminal through the first communication unit, and a control unit to perform at least one of changing at least one of the disallowed function into the allowed function and changing at least one of the allowed function into the disallowed function, based on the function information obtained from the terminal through the second communication unit.

3. The vehicle control system according to claim 2, wherein the vehicle control device comprises a determination unit to determine whether or not the terminal is present in a vehicle cabin, and performs at least one of changes on the allowed function and on the disallowed function based on the function information obtained from the terminal when the determination unit determines that the terminal is present in the vehicle cabin.

4. The vehicle control system according to claim 2, wherein when the terminal is located outside the vehicle, the vehicle control device turns a function of allowing for locking and unlocking of the vehicle into the allowed function based on the function information obtained from the terminal.

5. The vehicle control system according to claim 2, further comprising:
a server that transmits software, which generates the function information, to the terminal.

6. The vehicle control system according to claim 5, wherein the terminal has, based on the software obtained from the server, functions of generating the function information and reading and transmitting user's biometric information as registered biometric information to a start switch through the vehicle control device, wherein the vehicle control device changes a biometric authentication function pre-installed on the start switch from the disallowed function into the allowed function based on the function information obtained from the terminal, and wherein the start switch performs biometric authentication by comparing the biometric information, which is read with the biometric authentication function when an operation is performed, to the registered biometric information registered through the terminal.

7. The vehicle control system according to claim 6, wherein the terminal transmits the registered biometric information included in the function information to the start switch.

8. The vehicle control system according to claim 6, wherein the terminal reads a fingerprint as the biometric information, and wherein the biometric authentication function is configured to read a fingerprint as the biometric information and perform fingerprint authentication.

9. The vehicle control system according to claim 2, wherein the terminal comprises a mobile terminal including a smartphone and a tablet.

10. The vehicle control system according to claim 2, wherein the vehicle control device is mounted on the vehicle that is rented for a fee or shared.
